(19) United States
(12) Patent Application Publication
(10) Pub. No.: US 2026/0163320 A1
(43) Pub. Date: Jun. 11, 2026

(54) SIMPLE POSITION-LIMITING CONVERSION SOCKET

(71) Applicant: Dongguan Buffalo Electric Appliance Co., Ltd, Dongguan City (CN)

(72) Inventor: Ruhe Yuan, Jiujiang City (CN)

(21) Appl. No.: 19/240,420

(22) Filed: Jun. 17, 2025

(30) Foreign Application Priority Data
Dec. 5, 2024 (CN) 202411777255.9
Dec. 5, 2024 (CN) 202422992472.1

(51) Int. Cl. H01R 31/06; H01R 13/68

(52) U.S. Cl. CPC H01R 31/065; H01R 13/68

(57) ABSTRACT

A simple position-limiting conversion socket, comprising a case and a circuit board located inside the case, an inner frame, at least two power plugs, and conductive sheets corresponding to the power plugs, sliding grooves are arranged on one side of the inner frame facing the pushing heads, interference plates are placed inside the sliding grooves, the interference plates are movable relative to the sliding grooves. The invention sets the interference plates on the same side, so that each time power plugs are pushed, the interference plates are displaced; this displacement creates a staggered gap allowing the connecting rods of the pushed power plugs to pass through; it forms a barrier against the connecting rods of the other power plugs. Thus, by moving only one plate body, the problem of multiple power plugs being pushed out simultaneously can be easily avoided, ensuring operational safety while effectively controlling internal space occupancy.

### 1. TECHNICAL FIELD

The invention relates to the technical field of conversion sockets, in particular to a simple position-limiting conversion socket.

### 2. BACKGROUND ART

A conversion socket, literally understood, is a device that enables one type of plug to be converted into another. More commonly, it refers to a tool that can transform power plugs from different countries or from a specific country into power plugs suitable for another country or multiple countries, allowing power plugs from multiple countries or a particular country to be inserted into sockets in another country. This facilitates the interoperability of plugs from different countries across the globe, solving the problem of enabling electrical appliances from various countries to be used in other countries.

Currently, the existing conversion sockets have a structural design where one end is equipped with a socket that can accommodate plugs of various specifications. The socket is embedded with corresponding plug sleeves, and the other end is fitted with plugs of multiple specifications. When not in use, the plugs can all be retracted into the interior, the interior is generally provided with a circuit board. Since the conversion socket is designed to be portable for travel, it is generally preferred to be compact. However, in order to prevent the risk of the other plug extending when one plug is extended (if they are extended at the same time, it may lead to short circuits or interfere with normal use due to the contact between the plug prongs), some limiting structures are added internally to restrict the extension of the plugs. A common limiting structure relies on a spring and corresponding pin and locking mechanism for each plug component. This ensures that after a single plug is extended or retracted, it is locked in place, preventing automatic retraction. However, this design only addresses automatic push-back of the plug. In cases of incorrect operation, other plugs could still be extended simultaneously, which presents a risk. It does not guarantee that only one plug will extend at a time. Furthermore, each limiting structure increases the internal space, making the design of existing conversion sockets larger.

### 3. SUMMARY OF THE INVENTION

In view of the deficiencies existing in the above prior art, the object of the invention is to provide a simple position-limiting conversion socket

In order to realize the above object, the invention provides the following technical scheme:
the simple position-limiting conversion socket, comprising a case and a circuit board located inside the case, an inner frame, at least two power plugs, and conductive sheets corresponding to the power plugs, clearance holes are arranged at one end face of the case, directly opposite to the positions of the power plugs, receptacles are arranged at the other end face of the case, conductive plug sleeves are arranged inside the case relative to the receptacles, each power plug is slidably mounted on the inner frame through a sliding cavity, each power plug is equipped with a pushing seat with insulating properties, each pushing seat is provided with a pushing head located outside the case via a connecting rod, the conductive sheets are mounted on the inner frame, insertion ports of each conductive sheet correspond to the pushing trajectories of the respective power plugs, after the plugs of the power plugs are pushed out from the clearance holes, the conductive parts of the power plugs are respectively in contact the conductive sheets, both the conductive sheets and the conductive plug sleeves are electrically connected to the circuit board, the pushing heads on each pushing seat are located on the same side of the inner frame, sliding grooves are arranged on one side of the inner frame facing the pushing heads, interference plates are placed inside the sliding grooves, the interference plates are movable relative to the sliding grooves, after sliding, only one gap remains between interference plates or between the interference plates and the upper and lower ports of the sliding grooves, the gap is used for pushing in a single connecting rod; end faces of one end of the interference plates are provided with guiding inclined surfaces, so that when the connecting rods contact the guiding inclined surfaces of the interference plates, they are figured to force the interference plates to move within the sliding grooves.

Preferably, the inner frame is detachably installed inside the case.

Preferably, each sliding groove includes a first notch arranged at a front end of the inner frame and a second notch arranged at a rear end of the inner frame, both ends of each interference plate are respectively placed within the first notch and the second notch.

Preferably, the connecting rod is provided with a chamfered surface on one side near the guiding inclined surfaces.

Preferably, the pushing seat is embedded and installed at one end of the power plug, allowing the pushing seat to move laterally relative to the power plug, at least one spring is arranged between the pushing seat and the power plug, each time the pushing seat moves laterally, the spring is compressed, the inner frame is provided with at least one limiting port at both the front and rear ends of the sliding cavity; the pushing seat is provided with a limiting edge corresponding to the limiting port, each time the limiting edge moves to the limiting port, the spring is configured to push the limiting edge into the limiting port.

Preferably, at least one embedded block is arranged on the pushing seat, the power plug is provided with an embedding part, the pushing seat passes laterally through the embedding part and is configured to move along the lateral position of the embedding part, the pushing seat is provided with an embedding opening, and the embedded block is placed inside the embedding opening, when the power plug is a European standard plug, guiding blocks are arranged on the embedded block, a housing of the European standard power plug is provided with guiding holes, and the guiding blocks are placed inside the guiding holes, corresponding alignment openings and alignment edges are arranged around the peripheries of the embedding opening and the embedded block.

Preferably, each of the power plugs and the sliding cavities is provided with a clearance space, the power plugs are stacked vertically on the inner frame by utilizing the clearance space.

Preferably, the conductive sheets and the conductive plug sleeves are connected to the circuit board via fuses

Due to the adoption of the above scheme, the invention sets the interference plates on the same side, so that each time power plugs are pushed, the interference plates are displaced; on one hand, this displacement creates a staggered gap allowing the connecting rods of the pushed power plugs to pass through; on the other hand, it forms a barrier against the connecting rods of the other power plugs. Thus, by moving only one plate body, the problem of multiple power plugs being pushed out simultaneously can be easily avoided, ensuring operational safety while effectively controlling internal space occupancy compared with other limiting structures. At the same time, each power plug is equipped with a clearance space along the path that another power plug must pass through. This allows the structure to be further reduced in size, resulting in a smaller inner frame and ultimately reducing the overall volume.

### 4. BRIEF DESCRIPTION OF ACCOMPANYING DRAWINGS

FIG. 1 is a schematic diagram of the structure of an embodiment of the invention.

FIG. 2 is a schematic diagram of the structure of the other side of the embodiment of the invention.

FIG. 3 is a schematic diagram of the structure of the interior of the embodiment of the invention.

FIG. 4 is a cross-sectional view of the interference plates of the embodiment of the invention.

FIG. 5 is a schematic diagram of the structure between the power plug and the sliding cavity of the embodiment of the invention.

FIG. 6 is a schematic diagram of the structure of the European standard power plug of the embodiment of the invention.

FIG. 7 is an exploded view of the structure of the European standard power plug of the embodiment of the invention in another direction.

FIG. 8 is a schematic diagram of the structure of the British standard power plug of the embodiment of the invention.

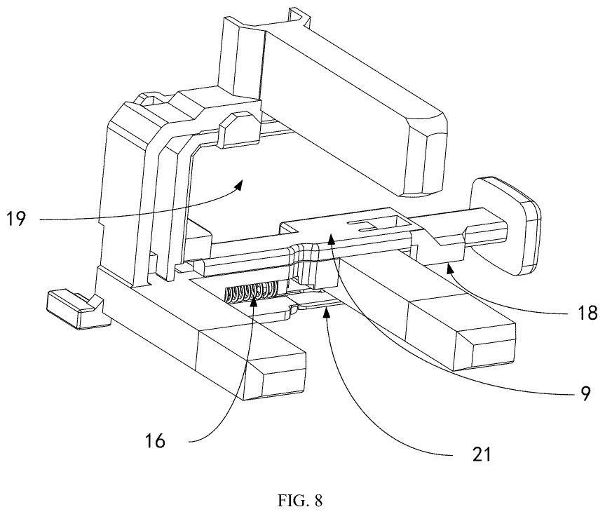

FIG. 9 is a schematic diagram of the structure of the American standard power plug of the embodiment of the invention.

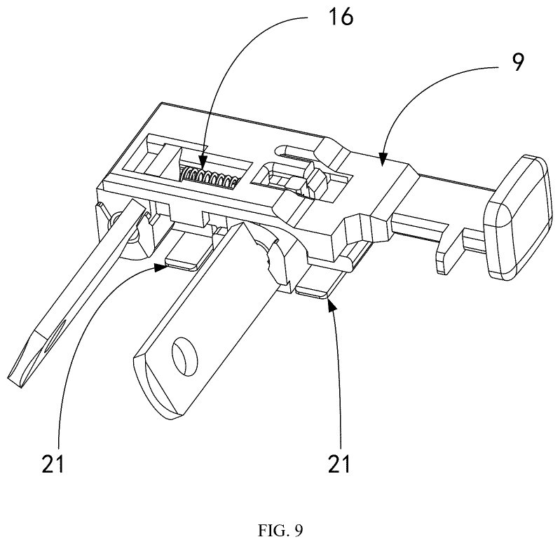

### 5. SPECIFIC EMBODIMENT OF THE INVENTION

In order to make the purpose, technical solution and advantages of the invention more clearly understood, the invention is further described in detail below in conjunction with the accompanying drawings and embodiments. It should be understood that the specific embodiments described herein are only used to explain the invention and are not intended to limit the invention.

In the description of the invention, it should be understood that the orientation or positional relationship indicated by the terms “center”, “longitudinal”, “transversal”, “length”, “width”, “thickness”, “upper”, “lower”, “front”, “rear”, “left”, “right”, “vertical”, “horizontal”, “top”, “bottom”, “inside”, “outside”, “clockwise”, “counterclockwise” and so on are based on the orientation or positional relationship shown in the accompanying drawings, only for the convenience of describing the invention and simplifying the description, rather than indicating or implying that the indicated device or element must have a specific orientation, as well as a specific orientation structure and operation, therefore, it should not be construed as a limitation of the invention. In addition, the terms of “first”, “second” and so on are only used to describe the object, and should not be understood as indicating or implying relative importance or implying the number of indicated technical features. Therefore, the features defined with “first” or “second” may expressly or implicitly include one or more of the features, and in the description of the invention, the meaning of “multiple” is two or more, unless otherwise expressly limited.

In the invention, unless otherwise expressly specified and limited, the terms “installation”, “connected”, “connection”, “fixed” and so on should be understood in a broad sense, for example, it may be a fixed connection or a detachable connection or integral connection; it can be a mechanical connection or an electrical connection; it can be a direct connection or an indirect connection through an intermediate medium, and it can be the internal connection between the two components. For those skilled in the art, the specific meanings of the above terms in the invention can be understood according to specific situations.

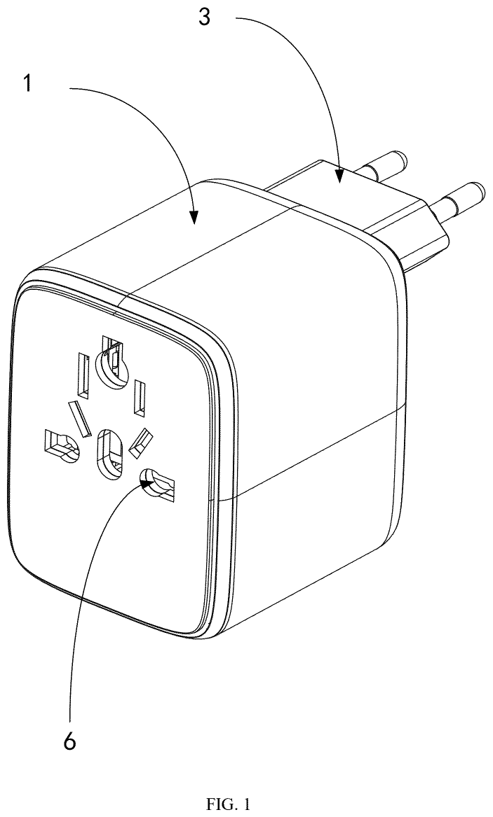

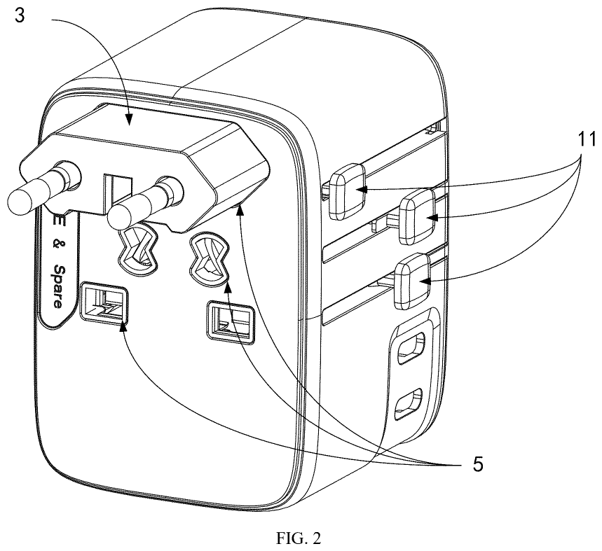

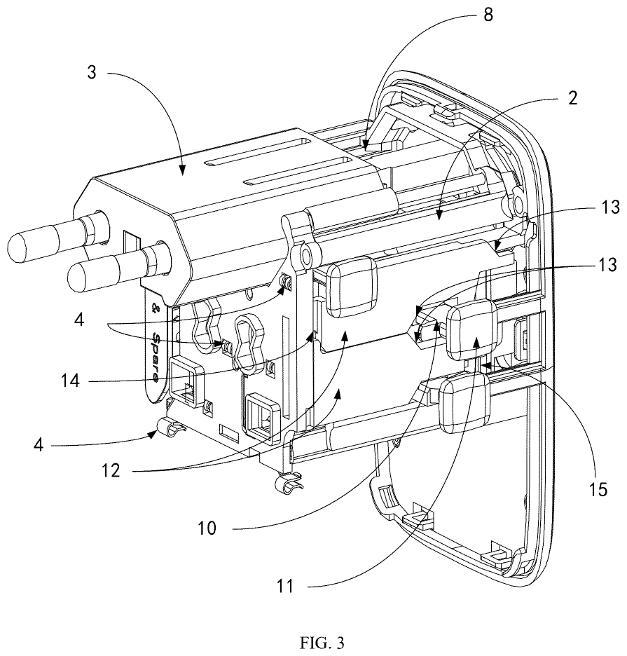

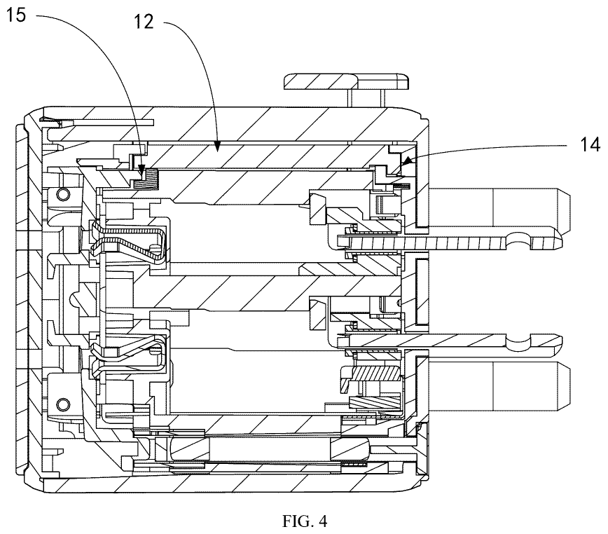

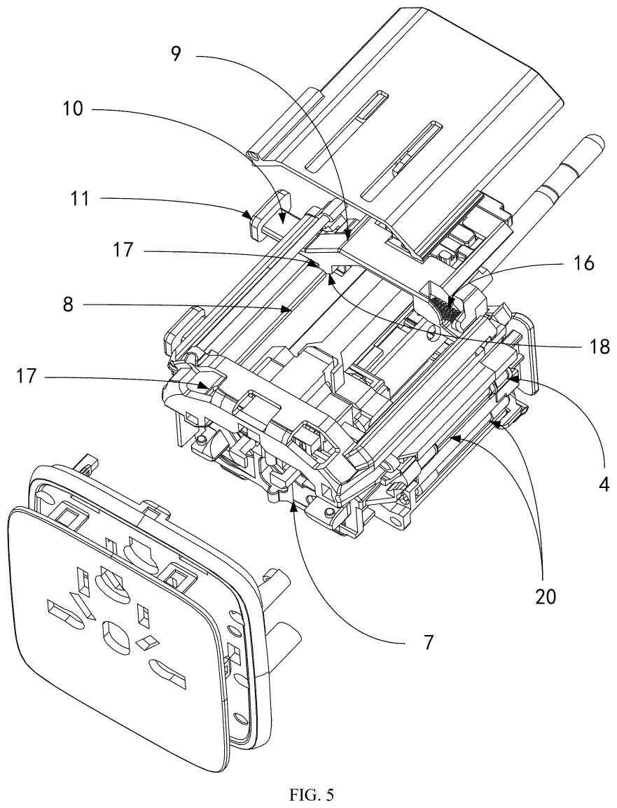

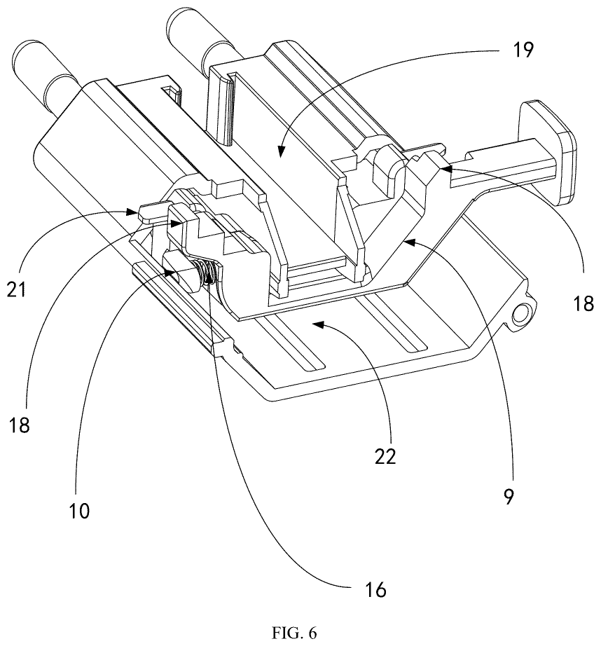

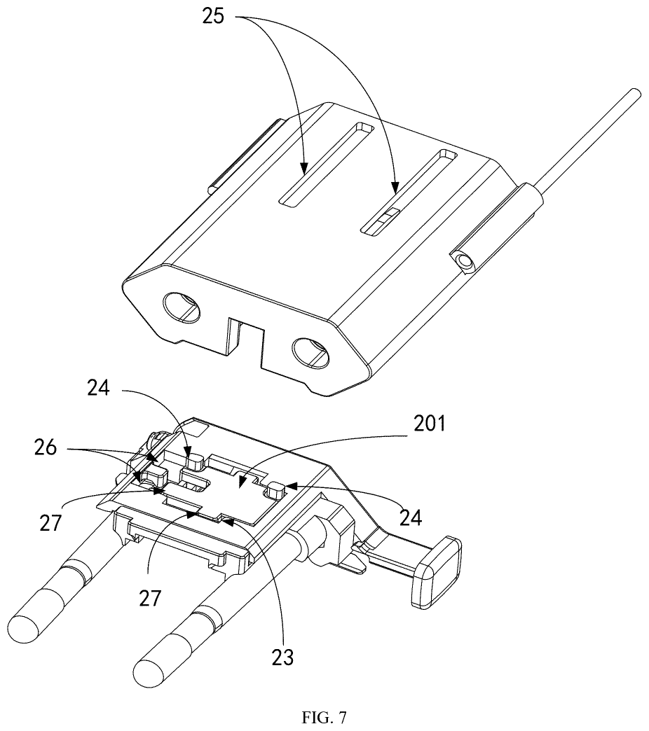

As shown in FIG. 1 to FIG. 7, the embodiment provides a simple position-limiting conversion socket, comprising a case 1 and a circuit board (not shown) located inside the case 1, an inner frame 2, at least two power plugs 3, and conductive sheets 4 corresponding to the power plugs 3, clearance holes 5 are arranged at one end face of the case 1, directly opposite to the positions of the power plugs 3, receptacles 6 are arranged at the other end face of the case 1, conductive plug sleeves 7 are arranged inside the case 1 relative to the receptacles 6, each power plug 3 is slidably mounted on the inner frame 2 through a sliding cavity 8, each power plug 3 is equipped with a pushing seat 9 with insulating properties, each pushing seat 9 is provided with a pushing head 11 located outside the case 1 via a connecting rod 10, the conductive sheets 4 are mounted on the inner frame 2, insertion ports of each conductive sheet 4 correspond to the pushing trajectories of the respective power plugs 3, after the plugs of the power plugs 3 are pushed out from the clearance holes 5, the conductive parts 21 of the power plugs 3 are respectively in contact the conductive sheets 4, both the conductive sheets 4 and the conductive plug sleeves 7 are electrically connected to the circuit board, the pushing heads 11 on each pushing seat 9 are located on the same side of the inner frame 2, sliding grooves are arranged on one side of the inner frame 2 facing the pushing heads 11, interference plates 12 are placed inside the sliding grooves, the interference plates 12 are movable relative to the sliding grooves; after sliding, only one gap remains between interference plates 12 or between the interference plates 12 and the upper and lower ports of the sliding grooves, which is used for pushing in a single connecting rod 10; end faces of one end of the interference plates 12 are provided with guiding inclined surfaces 13, so that when the connecting rods 10 contact the guiding inclined surfaces 13 of the interference plates 12, they are figured to force the interference plates 12 to move within the sliding grooves.

In this embodiment, interference plates 12 are arranged on the same side, so that each time power plugs 3 are pushed, the interference plates 12 are displaced; on one hand, this displacement creates a staggered gap allowing the connecting rods 10 of the pushed power plugs 3 to pass through; on the other hand, it forms a barrier against the connecting rods 10 of the other power plugs 3. Thus, by moving only one plate body, the problem of multiple power plugs 3 being pushed out simultaneously can be easily avoided, ensuring operational safety while effectively controlling internal space occupancy compared with other limiting structures.

For a clearer explanation of the structural principle, the description is based on three power plugs 3 and two interference plates 12, where the three power plugs 3 can be respectively configured as European standard plug, British standard plug, and American standard plug. When it is necessary to push out the uppermost European standard plug, the pushing head 11 of the European standard power plug 3 is pushed outward, causing the European standard power plug 3 to be gradually pushed toward the direction of the clearance holes 5; during pushing, the connecting rod 10 of the European standard power plug 3 contacts the guiding inclined surface 13 at one end of the upper interference plate 12, which forces the two interference plates 12 to synchronously move toward one side of the sliding grooves, thereby pushing the connection rod 10 of the European standard electrical plug 3 into placel; there will be no gaps between the interference plates 12, or between the interference plates 12 and the other side of the sliding grooves, preventing other power plugs 3 from being pushed out. When it is necessary to push out another power plug 3, the previously pushed power plug 3 must be returned to its original position before pushing the next one as required. For example, when pushing out the middle British standard power plug 3, its own connecting rod 10 contacts the guiding inclined surfaces 13 of the two interference plates 12, causing the two interference plates 12 to both sides respectively, thereby creating a gap between them to allow the British standard power plug 3 to be pushed out. When pushing out the lowermost American standard power plug 3, the principle is the same as that for the European standard power plug 3: after pushing, the connecting rod 10 acts on the guiding inclined surfaces 13, forcing the two interference plates 12 to move upward together to form the gap required for the American standard power plug 3 to be pushed out. Each power plug 3, once pushed out, contacts the corresponding conductive sheets 4 to establish electrical conduction, thereby enabling power supply connection.

Further, the inner frame 2 in this embodiment is detachably installed inside the case 1, for example, by screws. This detachable installation allows all internal components mounted on the inner frame 2 to exist as a single modular assembly, facilitating subsequent maintenance and replacement, as well as convenient standalone sales of this assembly module.

Further, regarding the sliding design of the interference plates 12, each sliding groove of the embodiment includes a first notch 14 arranged at a front end of the inner frame 2 and a second notch 15 arranged at a rear end of the inner frame 2, both ends of each interference plate 12 are respectively placed within the first notch 14 and the second notch 15. In this way, the interference plate 12 is limited by the first notch 14 and the second notch 15 to form a bidirectional fit, allowing the interference plate 12 to slide more stably.

Further, the pushing of the interference plate 12 mainly relies on the opposing force between the end face of the connecting rod 10 and the guiding inclined surfaces 13. Therefore, in order to enable smoother pushing of the interference plate 12, the connecting rod 10 in this embodiment is provided with a chamfered surface on the side near the guiding inclined surfaces 13. The contact between the chamfered surface and the guiding inclined surfaces 13 can better push the interference plate 12, enabling the interference plate 12 to slide.

Further, in order to lock the position after the power plug 3 is pushed out or retracted, preventing movement caused by non-manual forces, the pushing seat 9 in this embodiment is embedded and installed at one end of the power plug 3, allowing the pushing seat 9 to move laterally relative to the power plug 3, at least one spring 16 is arranged between the pushing seat 9 and the power plug 3; each time the pushing seat 9 moves laterally, the spring 16 is compressed; the inner frame 2 is provided with at least one limiting port 17 at both the front and rear ends of the sliding cavity 8; the pushing seat 9 is provided with a limiting edge 18 corresponding to the limiting port 17; each time the limiting edge 18 moves to the limiting port 17, the spring 16 is configured to push the limiting edge 18 into the limiting port 17.

Further, regarding the specific structure for the pushing seat 9 to move laterally relative to the power plug 3, at least one embedded block 21 is arranged on the pushing seat 9 in this embodiment, the power plug 3 is provided with an embedding part 22, the pushing seat 9 passes laterally through the embedding part 22 and is configured to move along the lateral position of the embedding part 22, the pushing seat 9 is provided with an embedding opening 23, and the embedded block 21 is placed inside the embedding opening 23; when the power plug 3 is a European standard plug, guiding blocks 24 are arranged on the embedded block 21, a housing of the European standard power plug 3 is provided with guiding holes 25, and the guiding blocks 24 are placed inside the guiding holes 25, corresponding alignment openings 26 and alignment edges 27 are arranged around the peripheries of the embedding opening 23 and the embedded block 21. In this way, lateral movement of the pushing seat 9 can be realized, and the volume can be effectively reduced, making the structure more compact.

Further, in order to reduce the volume, each of the power plugs 3 and the sliding cavities 8 in this embodiment is provided with a clearance space 19, the power plugs 3 are stacked vertically on the inner frame 2 by utilizing the clearance space 19. This allows for a rational design of the internal space, making the structure more compact and reducing the overall volume.

Further, in order to ensure circuit safety, the conductive sheets 4 and the conductive plug sleeves 7 in this embodiment are connected to the circuit board via fuses 20, the fuses 20 are plug-in mounted on the inner frame 2, and the fuses 20 are configured to be cylindrical ceramic fuses.

The above are only preferred embodiments of the invention, and do not limit the patent scope of the invention. Any equivalent structure or equivalent process transformation made by using the contents of the specification and drawings of the invention, or directly or indirectly applied in other related technical fields, are also included in the patent protection scope of the invention.

1. A simple position-limiting conversion socket, comprising a case and a circuit board located inside the case, an inner frame, at least two power plugs, and conductive sheets corresponding to the power plugs, clearance holes are arranged at one end face of the case, directly opposite to the positions of the power plugs, receptacles are arranged at the other end face of the case, conductive plug sleeves are arranged inside the case relative to the receptacles, each power plug is slidably mounted on the inner frame through a sliding cavity, each power plug is equipped with a pushing seat with insulating properties, each pushing seat is provided with a pushing head located outside the case via a connecting rod, the conductive sheets are mounted on the inner frame, insertion ports of each conductive sheet correspond to the pushing trajectories of the respective power plugs, after the plugs of the power plugs are pushed out from the clearance holes, the conductive parts of the power plugs are respectively in contact the conductive sheets, both the conductive sheets and the conductive plug sleeves are electrically connected to the circuit board, the pushing heads on each pushing seat are located on the same side of the inner frame, sliding grooves are arranged on one side of the inner frame facing the pushing heads, interference plates are placed inside the sliding grooves, the interference plates are movable relative to the sliding grooves, after sliding, only one gap remains between interference plates or between the interference plates and the upper and lower ports of the sliding grooves, the gap is used for pushing in a single connecting rod; end faces of one end of the interference plates are provided with guiding inclined surfaces, so that when the connecting rods contact the guiding inclined surfaces of the interference plates, they are figured to force the interference plates to move within the sliding grooves.

2. The simple position-limiting conversion socket of claim 1, wherein the inner frame is detachably installed inside the case.

3. The simple position-limiting conversion socket of claim 1, wherein each sliding groove includes a first notch arranged at a front end of the inner frame and a second notch arranged at a rear end of the inner frame, both ends of each interference plate are respectively placed within the first notch and the second notch.

4. The simple position-limiting conversion socket of claim 3, wherein the connecting rod is provided with a chamfered surface on one side near the guiding inclined surfaces.

5. The simple position-limiting conversion socket of claim 4, wherein the pushing seat is embedded and installed at one end of the power plug, allowing the pushing seat to move laterally relative to the power plug, at least one spring is arranged between the pushing seat and the power plug, each time the pushing seat moves laterally, the spring is compressed, the inner frame is provided with at least one limiting port at both the front and rear ends of the sliding cavity; the pushing seat is provided with a limiting edge corresponding to the limiting port, each time the limiting edge moves to the limiting port, the spring is configured to push the limiting edge into the limiting port.

6. The simple position-limiting conversion socket of claim 5, wherein at least one embedded block is arranged on the pushing seat, the power plug is provided with an embedding part, the pushing seat passes laterally through the embedding part and is configured to move along the lateral position of the embedding part, the pushing seat is provided with an embedding opening, and the embedded block is placed inside the embedding opening, when the power plug is a European standard plug, guiding blocks are arranged on the embedded block, a housing of the European standard power plug is provided with guiding holes, and the guiding blocks are placed inside the guiding holes, corresponding alignment openings and alignment edges are arranged around the peripheries of the embedding opening and the embedded block.

7. The simple position-limiting conversion socket of claim 6, wherein each of the power plugs and the sliding cavities is provided with a clearance space, the power plugs are stacked vertically on the inner frame by utilizing the clearance space.

8. The simple position-limiting conversion socket of claim 1, wherein the conductive sheets and the conductive plug sleeves are connected to the circuit board via fuses.
